(19) United States
(12) Patent Application Publication
(10) Pub. No.: US 2022/0415529 A1
(43) Pub. Date: Dec. 29, 2022

(54) HEAT EXCHANGER AND NUCLEAR POWER PLANT HAVING THE SAME

(71) Applicant: KOREA ATOMIC ENERGY RESEARCH INSTITUTE, Daejeon (KR)

(72) Inventors: Hyunjun CHO, Daejeon (KR); June Woo KEE, Daejeon (KR); Seok KIM, Daejeon (KR); Young In KIM, Daejeon (KR); Joo Hyung MOON, Daejeon (KR); Yunbum PARK, Daejeon (KR); Soo Jai SHIN, Daejeon (KR); Seungyeob RYU, Daejeon (KR); Minkyu LEE, Daejeon (KR); Cheongbong CHANG, Daejeon (KR); Hun Sik HAN, Daejeon (KR); Sung Deok HONG, Daejeon (KR)

(73) Assignee: KOREA ATOMIC ENERGY RESEARCH INSTITUTE, Daejeon (KR)

(21) Appl. No.: 17/849,489

(22) Filed: Jun. 24, 2022

(30) Foreign Application Priority Data
Jun. 24, 2021 (KR) 10-2021-0082360

(51) Int. Cl. G21C 15/18; G21C 15/14; G21C 15/243

(52) U.S. Cl. CPC G21C 15/18; G21C 15/14; G21C 15/243

(57) ABSTRACT

A heat exchanger includes a body having an inlet header through which a fluid is introduced, and an outlet header through which the fluid is discharged; and one or more plates accommodated in the body and provided with flow path modules providing flow paths for the fluid introduced through the inlet header to flow to the outlet header. The heat exchanger further includes at least one flow path adjuster each having at least a portion thereof accommodated in the body and being movable or rotatable to open or close a part or all of the flow paths or to change directions of the flow paths so that a flow of the fluid is adjusted.

### CROSS-REFERENCE TO RELATED APPLICATIONS

A claim for priority under 35 U.S.C. § 119 is made to Korean Patent Application No. 10-2021-0082360 filed on Jun. 24, 2021, in the Korean Intellectual Property Office, the entire contents of which are hereby incorporated by reference.

### TECHNICAL FIELD

The present disclosure relates to a heat exchanger and a nuclear power plant having the same. The present disclosure relates to the development of innovative SMART system technologies of the SMART innovative technology development project (R&D) with support from the National Research Foundation of Korea, which was funded by the Ministry of Science and ICT. The Project Serial Number of the national R&D project supporting the present disclosure is 1711129153, the Project number is 2020M2D7A1079178, the contribution rate is 1/1, the project performing organization is Korea Atomic Energy Research Institute (KAERI), and the research was performed from Jan. 1, 2021 to Dec. 31, 2021.

### BACKGROUND

In general, power output of large commercial nuclear power plants is constantly maintained at 100%, and since the fuel costs of nuclear power plants are cheaper than other major power sources such as thermal power, it is economical to maintain 100% power output compared to other power sources. However, small and medium-sized nuclear reactors, which have recently been newly developed in the market, can be supplied to regions with low population density or islands, and in this case, because of a large fluctuation in demand, it may be difficult for the reactors to handle a base load while always operating at 100%.

In addition, even in developed countries with a high population density, as the ratio of new and renewable energy increases, the number of regions with a smart grid system which sells electricity at a price that fluctuates in seconds in the electricity trading market is increasing. In this case, when electricity supply exceeds electricity demand, the unit price of electricity may be very low. Accordingly, nuclear reactors having the ability to freely control the power output are recently being studied in order to improve the economic feasibility of nuclear power plants, which is one of the important business decision criteria of business operators considering the construction of nuclear power plants.

Meanwhile, a heat exchanger is required for a nuclear reactor to use heat generated in the core. Such a heat exchanger may be a printed circuit heat exchanger (PCHE). The printed circuit heat exchanger is a heat exchanger manufactured by creating flow paths in metal plates through chemical etching and then performing diffusion bonding among the metal plates. A heat exchanger formed by diffusion bonding and stacking rectangular flat plates generally has a rectangular parallelepiped block shape.

However, the optimal flow path length (which is relevant to the length of the rectangular parallelepiped) of a conventional printed-circuit type steam generator is designed to meet operating conditions for 100% power output. Accordingly, when a nuclear reactor is operated under a low-power condition, there may be a pressure loss due to an unnecessarily long flow path length.

### RELATED ART

(Patent Document) Korean Patent Application Publication No. 10-2020-0049300 (published on May 8, 2020)

### SUMMARY

In view of the above, the present disclosure provides a heat exchanger capable of reducing a pressure loss according to reactor operating conditions, especially, a printed circuit heat exchanger, and a nuclear power plant including the same.

In accordance with an aspect of the present disclosure, there is provided a heat exchanger including: a body having an inlet header through which a fluid is introduced, and an outlet header through which the fluid is discharged; one or more plates accommodated in the body and provided with flow path modules providing flow paths for the fluid introduced through the inlet header to flow to the outlet header; and at least one flow path adjuster each having at least a portion thereof accommodated in the body and being movable or rotatable to open or close a part or all of the flow paths or to change directions of the flow paths so that a flow of the fluid is adjusted.

According to an embodiment of the present disclosure, it is possible to adjust characteristics of the heat exchanger by using only a desired portion of a flow path formed in a plate through a flow path adjuster.

In addition, when necessary, for example, in low-power operation, flow instability may be suppressed by increasing a pressure loss coefficient of an inlet-side orifice through the flow path adjuster, and in the event of a nuclear incident, when residual heat removal such as a passive residual heat removal system is in progress, it is possible to increase the amount of heat removal by lowering a pressure loss of a flow path module through the flow path adjuster.

### BRIEF DESCRIPTION OF THE DRAWINGS

FIG. 1 is a view showing a printed circuit heat exchanger (PCHE) of a nuclear power plant according to an embodiment of the present disclosure.

FIGS. 2 to 5 are views showing a flow path module formed in a plate according to the embodiment of the present disclosure.

FIG. 6 is a view showing that an orifice formed in a flow path adjuster communicates with a connection flow path according to the embodiment of the present disclosure.

FIG. 7 is a view showing that an adjustment flow path instead of the orifice depicted in FIG. 6 is formed in the flow path adjuster to communicate with the connection flow path according to the embodiment of the present disclosure.

FIG. 8 is a view showing the flow path adjuster according to the embodiment of the present disclosure.

FIGS. 9A and 9B are views illustrating a state when the flow path adjuster is rotated about a second direction according to the embodiment of the present disclosure.

FIGS. 10A to 10C are views showing a state when the flow path adjuster is moved in a first direction according to the embodiment of the present disclosure.

FIGS. 11A and 11B are views showing a state when the flow path adjuster is moved in the second direction according to the embodiment of the present disclosure.

FIGS. 12A to 12C are view showing a plurality of adjustment flow paths when the flow path adjuster is moved in the first direction according to the embodiment of the present disclosure.

FIGS. 13A to 13C are views showing a plurality of adjustment flow paths when the flow path adjuster is moved in the second direction according to the embodiment of the present disclosure.

FIGS. 14A to 14C are views showing a plurality of adjustment flow paths when the flow path adjuster is rotated about the second direction according to the embodiment of the present disclosure.

FIGS. 15A to 15F are views showing an inflow path and a plurality of connecting passages when the flow path adjuster is rotated about the second direction according to the embodiment of the present disclosure.

FIGS. 16A to 16D and FIGS. 17A to 17H are views showing an inflow path and a plurality of connecting passages when the flow path adjuster is moved in the first direction according to the embodiment of the present disclosure.

FIGS. 18A to 18D are views showing an inflow path and a plurality of connecting passages when the flow path adjuster is moved in the second direction according to the embodiment of the present disclosure.

FIGS. 19 to 22 are views showing a state in which the connecting member according to the embodiment of the present disclosure is connected to a plurality of flow path adjusters.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘transferred’ to, or ‘contacted’ with another element, it should be understood that the element may be directly connected to, supported by, transferred to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a nuclear power plant 1 according to an embodiment of the present disclosure will be described with reference to the drawings.

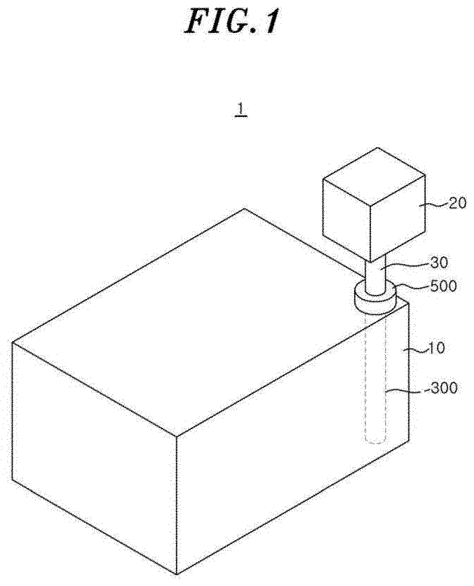

Referring to FIG. 1, the nuclear power plant 1 is a facility for causing nuclear fission through a nuclear reactor, and may generate power through steam generated by the nuclear fission. The nuclear power plant 1 may include a printed circuit heat exchanger (PCHE) 10, an actuator 20, and a connection member 30.

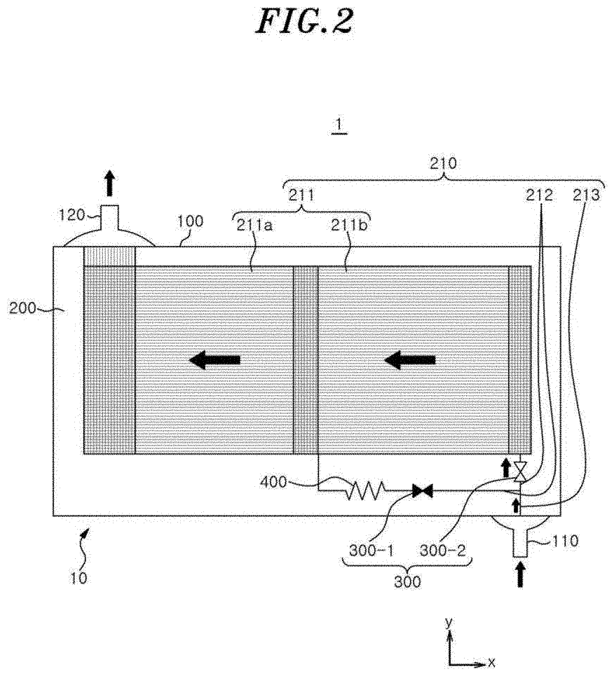

Referring to FIGS. 2 to 7, the heat exchanger 10 is a device in which a heat exchangeable high-temperature fluid and a heat exchangeable low-temperature fluid can flow. The heat exchanger 10 may be a printed circuit heat exchanger (PCHE). A high-temperature fluid and a low-temperature fluid may be introduced into the printed circuit heat exchanger (PCHE) 10 to exchange heat with each other. Hereinafter, the high-temperature fluid introduced into the printed circuit heat exchanger 10 is referred to as a first fluid, and the low-temperature fluid introduced into the printed circuit heat exchanger 10 is referred to as a second fluid. In addition, the first fluid may be a reactor coolant of relatively high temperature, and the second fluid may be water of relatively low temperature. In addition, the first fluid is heat-exchanged with the second fluid to have a low temperature and is then discharged from the printed circuit heat exchanger 10, and the second fluid is heat-exchanged with the first fluid to have a high temperature and is then discharged from the heat exchanger 10. In addition, the heat exchanger 10 may be a steam generator. Due to the steam generator, the second fluid may boil, in a second flow path module which will be described later, by heat received from the first fluid to be converted into steam.

In addition, the printed circuit heat exchanger 10 may be provided in plural. The printed circuit heat exchangers 10 may be spaced apart from each other or may be stacked. For example, the plurality of printed circuit heat exchangers 10 may be arranged along a second direction which will be described later. The printed circuit heat exchanger 10 may include a body 100, a plate 200, a flow path adjuster 300, and an orifice 400.

The body 100 may include a housing forming an overall appearance of the printed circuit heat exchanger 10 and a frame supporting other components. The body 100 may accommodate a plurality of plates 200. In addition, an inlet header 110 and an outlet header 120 may be formed in the body 100.

The inlet header 110 may provide a plurality of flow paths for a fluid to be introduced into the printed circuit heat exchanger 10. In other words, the fluid may be introduced into the printed circuit heat exchanger 10 through the inlet header 110. In addition, the inlet header 110 may be formed in plural. A plurality of inlet headers 110 may include a first inlet header into which the first fluid flows and a second inlet header into which the second fluid flows.

The outlet header 120 may discharge a fluid flowing inside the printed circuit heat exchanger 10 to the outside of the printed circuit heat exchanger 10. In addition, the outlet header 120 may be formed in plural. A plurality of outlet headers 120 may include a first outlet header through which the first fluid is discharged and a second outlet header through which the second fluid is discharged.

In the plate 200, a flow path module 210 providing a plurality of flow paths for a fluid introduced from the inlet header 110 to flow to the outlet header 120 may be formed. In other words, the flow path module 210 may be connected to the inlet header 110 and the outlet header 120. In addition, a plurality of plates 200 may be formed and stacked on each other. Such a plurality of plates may be assembled by diffusion bonding. The plurality of plates 200 may include a plurality of first plates and a plurality of second plates, and the plurality of first plates and the plurality of second plates may be alternately stacked. The first fluid may flow through flow path modules 210 of the plurality of first plates, and the second fluid may flow through flow path modules 210 of the plurality of second plates. Hereinafter, a flow path module 210 formed in the first plate will be referred to as a first flow path module, and a flow path module 210 formed in the second plate will be referred to as a second flow path module. The flow path modules 210 may include transfer flow path portions 211, connection flow paths 212, inflow paths 213, and adjuster rooms 214.

The transfer flow path portions 211 may communicate with each other and provide a plurality of flow paths for allowing a fluid to flow to the outlet header 120. The transfer flow path portion 211 may be formed in plural. In this case, a fluid may flow to at least one of the plurality of transfer flow path portion 211 by the flow path adjuster 300. For example, a plurality of transfer flow path portions 211 may be arranged along a flow direction of the fluid. The plurality of transfer flow path portions 211 may include a first transfer flow path portion 211a and a second transfer flow path portion 211b.

The first transfer flow path portion 211a may communicate with the outlet header 120, and the second transfer flow path portion 211b may communicate with the first transfer flow path portion 211a. A fluid may flow into at least one of the first transfer flow path portion 211a and the second transfer flow path portion 211b by the flow path adjuster. In other words, the fluid may sequentially pass through the second transfer flow path portion 211b and the first transfer flow path portion 211a by the flow path adjuster 300 to flow to the outlet header 120, or may flow to the outlet header 120 through the second transfer flow path portion 211b without flowing to the first transfer flow path portion 211a.

The connection flow path 212 may be connected to each transfer flow path portion 211 to provide a flow path for transferring a fluid introduced from the inlet header 110 to the plurality of transfer flow path portions 211. For example, the plurality of connection flow paths 212 may be connected to flow paths of the first transfer flow path portion 211a and flow paths of the second transfer flow path portion 211b, respectively. In addition, at least one of the plurality of connection flow paths 212 may be opened and closed by at least one flow path adjuster 300. In other words, a fluid may flow to at least one of the plurality of transfer flow path portion 211 through at least one of the plurality of connection flow paths 212.

An inflow path 213 may provide a flow path through which the fluid introduced from the inlet header 110 flows to at least a portion of the plurality of connection flow paths 212. In other words, the inflow path 213 may be connected to the inlet header 110 and the plurality of connection flow paths 212. Due to the inflow path 213, the fluid introduced from the inlet header 110 may flow into an opened connection flow path 212 among the plurality of connection flow paths 212.

The adjuster room 214 may provide a space in which the flow path adjuster 300 moves. In other words, the flow path adjuster 300 moves inside the adjuster room 214 to open and/or close at least one of the plurality of connection flow paths 212. The adjuster room 214 may be disposed in the plurality of connection flow paths 212 or may be disposed at a portion where the inflow path 213 and the plurality of connection flow paths 212 are joined. In addition, when the adjuster room 214 is disposed at a portion where the inflow path 213 and the plurality of connection flow paths 212 are joined, the fluid flowing in the inflow path 213 may flow through the adjuster room 214 into an opened connection flow path 212 among the plurality of connection flow path 212. In addition, a length of the inner space of the adjuster room 214 in the first direction may be greater than a length of the flow path adjuster 300 in the first direction in a case where the flow path adjuster 300 moves in the first direction. In other words, the adjuster room 214 may provide a space for the flow path adjuster 300 to move in the first direction.

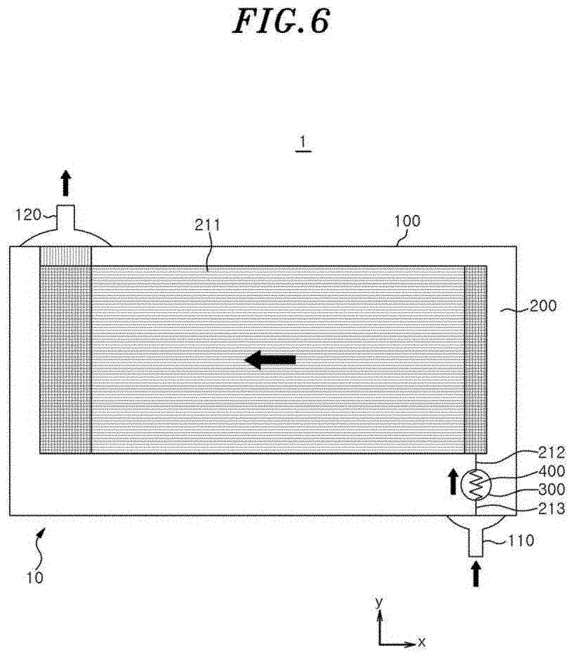

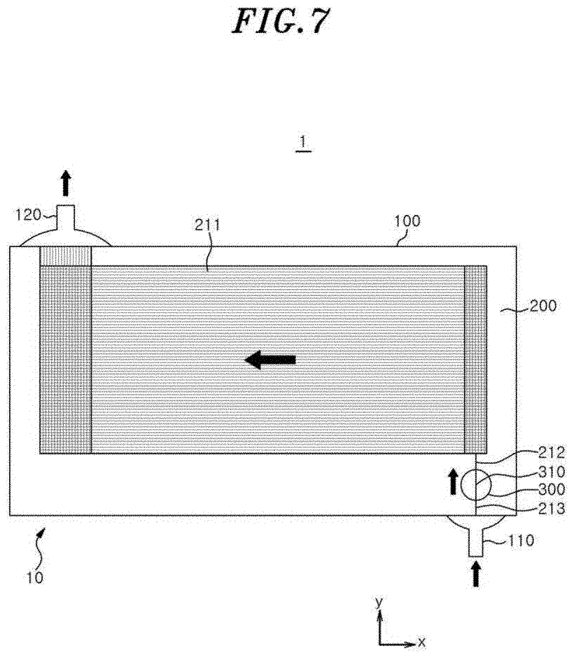

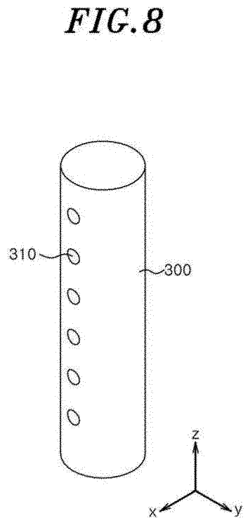

At least a portion of the flow path adjuster 300 may be accommodated in the body 100 and may be moved by the actuator 20 to control the flow of the fluid. In other words, by moving or rotating in one direction, the flow path adjuster 300 may selectively open or close part or all of the flow path provided in the flow path module 210 or may change a direction of the flow path. For example, as shown in FIG. 8, the flow path adjuster 300 may be formed in various ways, such as a cylinder, a rectangular prism, a triangular prism, a polygonal prism, a cone, and any other polygonal pyramid.

At least a part of the flow path adjuster 300 may be accommodated in the adjuster room 214. In addition, the flow path adjuster 300 may pass through the plurality of plates 200 and the body 100 to control the flow of the fluid flowing in a flow path module 210 of each plate 200. For example, the flow path adjuster 300 may pass through the plurality of plates 200 to control at least one of a flow of the first fluid flowing in the first flow module and/or a flow of the second fluid flowing in the second flow module. In addition, the flow path adjuster 300 may be disposed in at least one of the first flow path module and the second flow path module.

A gasket may be provided between the flow path adjuster 300 and the plate 200 in order to prevent a fluid from leaking. The gasket may be formed of metal.

In addition, the flow path adjusters 300 may be provided in plural to control a flow of fluid flowing in the flow path module 210. A plurality of flow path adjusters 300 may be provided in the heat exchanger 10. Also, the plurality of flow path adjusters 300 may be provided in one heat exchanger 10. In addition, in a case where a plurality of heat exchangers 10 is arranged along the second direction, the plurality of flow path adjusters 300 may be arranged in the second direction and formed integrally with each other. In other words, one flow path adjuster 300 may pass through bodies 100 of the plurality of heat exchangers 10 arranged in the second direction.

In addition, in order to control the flow of a fluid, the flow path adjuster 300 may move in a first direction along a surface of the plate 200, rotate about the first direction, move along the second direction crossing the first direction, or rotate about the second direction. The flow path adjuster 300 may be disposed at each of the plurality of connection flow paths 212, or may be disposed at a portion where the plurality of connection flow paths 212 are joined with each other. For example, the second direction crossing the first direction may be a direction perpendicular to the surface of the plate 200 (z direction in the drawing), but the present disclosure is not limited thereto.

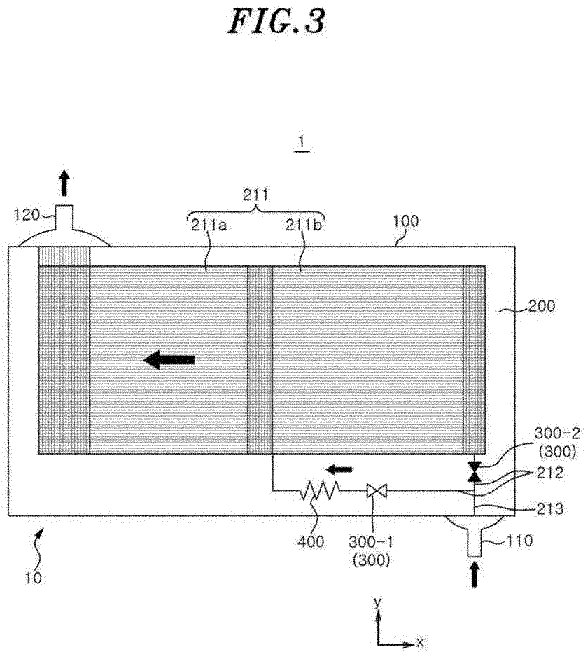

First, with reference to FIGS. 2 and 3, it will be described that a plurality of flow path adjusters 300 is respectively provided and disposed at the plurality of connection flow paths 212.

The plurality of flow path adjusters 300 may be moved along the first direction or the second direction by the actuator 20 or may be rotated about the second direction to open and close the plurality of connection flow paths 212. The plurality of flow path adjusters 300 each may be a gate valve, but the present disclosure is not limited thereto.

For example, as shown in FIGS. 2 and 3, the plurality of flow path adjusters 300 may include a first flow path adjuster 300-1 and a second flow path adjuster 300-2. The first flow path adjuster 300-1 may be moved along the first direction or the second direction or may be rotated about the second direction to open and/or close the first connection flow path which is one of the plurality of connection flow paths 212. The second flow path adjuster 300-2 may be moved along the first direction or the second direction or may be rotated about the second direction to open and close the second connection flow path which is the other one of the plurality of connection flow paths 212. In other words, as shown in FIG. 2, in a case where the first flow path adjuster 300-1 closes the first connection flow path and the second flow path adjuster 300-2 opens the second connection flow path, a fluid may flow to the second transfer flow path portion 211b through the second connection flow path. In addition, as shown in FIG. 3, in a case where the first flow path adjuster 300-1 opens the first connection flow path and the second flow path adjuster 300-2 closes the second connection flow path, a fluid may flow to the first transfer flow path portion 211a through the first connection flow path.

At least one adjustment flow path 310 may be formed in the flow path adjuster 300. The at least one adjustment flow path 310 may be formed through chemical etching or machining A plurality of adjustment flow paths 310 may be arranged to be spaced apart from each other in the first direction or in the second direction. In addition, the plurality of adjustment flow paths 310 may be disposed to be closer to any one of both side surfaces of the flow path adjuster 300.

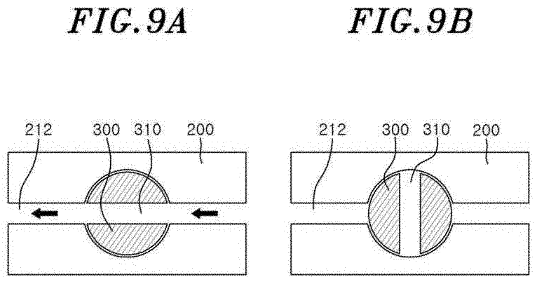

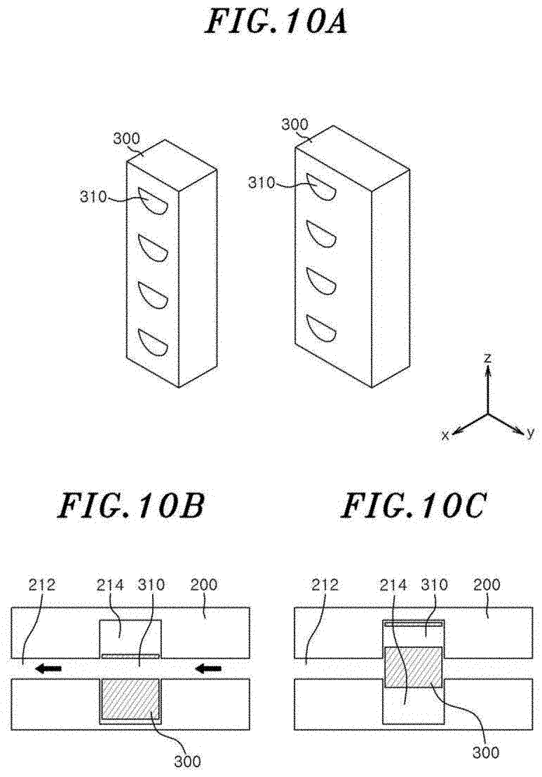

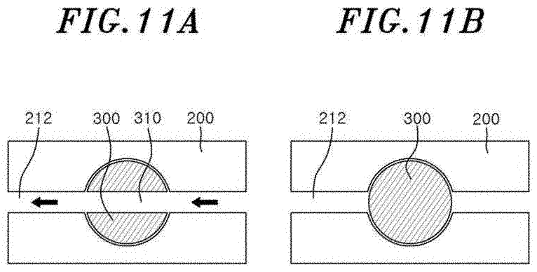

When the adjustment flow path 310 communicates with the connection flow path 212 by movement of the flow path adjuster 300, the connection flow path 212 is opened, and when the adjustment flow path 212 is blocked from the connection flow path 212, the connection flow path 212 may be closed. In other words, a fluid flowing in the connection flow path 212 may be directed to the transfer flow path portion 211 through the adjustment flow path 310. For example, as shown in FIGS. 9A and 9B, the flow path adjuster 300 is rotated about the second direction (the z direction in FIG. 8) by the actuator 20 to selectively open and/or close the connection flow path 212. In another example, as shown in FIGS. 10A to 10C, the flow path adjuster 300 may be moved in the first direction (a direction perpendicular to a direction in which the connection flow path 212 of FIGS. 10B and 10C extends) by the actuator 20 to selectively open and close the connection flow path 212. However, although FIGS. 10A to 10C shows that a moving direction of the flow path adjuster 300 is perpendicular to a direction that the connection flow path 212 extends, the present disclosure does not necessarily limit the moving direction of the flow path adjuster 300 thereto, and the moving direction of the flow path adjuster 300 may be one of directions intersecting the direction in which the connection flow path 212 extends. In another example, as shown in FIGS. 11A and 11B, the flow path adjuster 300 may be moved in the second direction by the actuator 20 to selectively open and/or close the connection flow path 212.

In addition, a plurality of adjustment flow paths may be formed, and the plurality of adjustment flow paths 310 and 320 may be formed with different widths to provide different pressure loss coefficients. In general, the smaller the width is, the greater the pressure loss coefficient is. In other words, the plurality of adjustment flow paths 310 and 320 formed with different widths may change flow resistance of the connection flow path 212 or the inflow path 213. The widths of the plurality of adjustment flow paths 310 and 320 refer to a length in a direction perpendicular to the direction in which the connection flow path 212 extends and a direction perpendicular to the second direction, but the present disclosure is not limited thereto. In other words, the plurality of adjustment flow paths 310 and 320 may be formed in different shapes. For example, the plurality of adjustment flow paths 310 and 320 may have different depths. The depths of the plurality of adjustment flow paths 310 and 320 refer to lengths in the second direction.

In addition, the plurality of adjustment flow paths 310 and 320 include at least one first adjustment flow path 310 and at least one second adjustment flow path 320, and a width of a first adjustment flow path 310 may be formed larger than a width of a second adjustment flow path 320.

The plurality of adjustment flow paths 310 and 320 moved so that one of the plurality of adjustment flow paths 310 and 320 may communicate with the connection flow path 212, the other one of the plurality of adjustment flow paths 310 and 320 may communicate with the connection flow path 212, or the communication between the plurality of adjustment flow paths 310 and 320 and the connection flow path 212 may be blocked. In other words, the first adjustment flow path 310 may communicate with the connection flow path 212, or the second adjustment flow path 320 may communicate with the connection flow path 212.

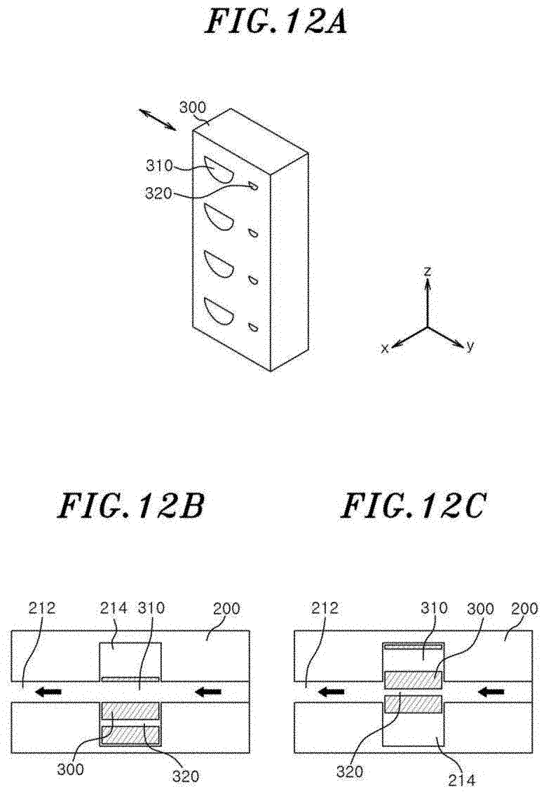

For example, as shown in FIGS. 12A to 12C, the first adjustment flow path 310 and the second adjustment flow path 320 may be disposed to be spaced apart from each other in the first direction (the y direction in FIG. 12A). In addition, a plurality of first adjustment flow paths 310 may be provided and disposed to be spaced apart from each other in the second direction (the z direction in FIG. 12A), and a plurality of second adjustment flow paths 320 may be provided and disposed to be spaced apart from each other in the second direction. The flow path adjuster 300 may be moved in the first direction so that one of the plurality of adjustment flow paths 310 and 320 communicates with the connection flow path 212 or the plurality of adjustment flow paths 310 and 320 are blocked from communicating with the connection flow path 212. In other words, one of the first adjustment flow path 310 and the second adjustment flow path 320 may communicate with the connection flow path 212 by the flow path adjuster 300 that is moved in the first direction.

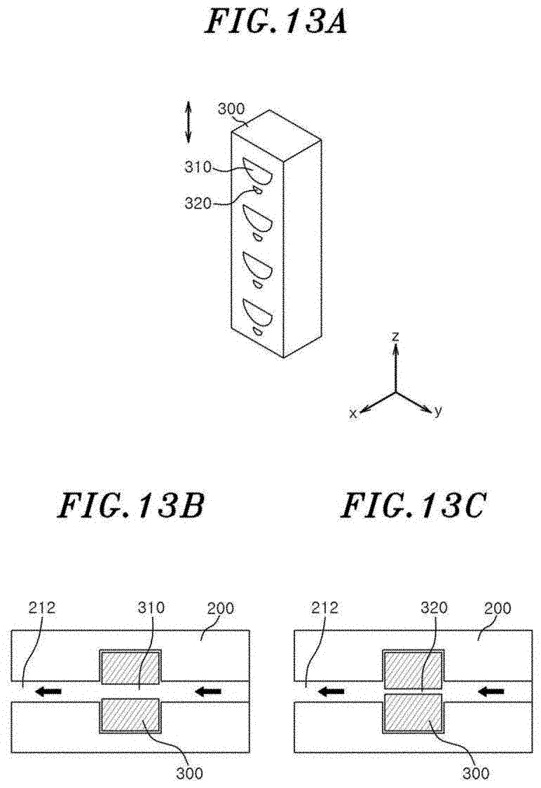

In another example, as shown in FIGS. 13A to 13C, the first adjustment flow path 310 and the second adjustment flow path 320 may be spaced apart from each other in the second direction (the z-direction in FIG. 13A) and alternately disposed in the second direction. The flow path adjuster 300 may be moved in the second direction so that any one of the plurality of adjustment flow paths 310 and 320 communicates with the connection flow path 212 or the plurality of adjustment flow paths 310 and 320 are prevented from communicating with the connection flow path 212. In other words, any one of the first adjustment flow path 310 and the second adjustment flow path 320 may communicate with the connection flow path 212 by the flow path adjuster 300 that is moved in the second direction.

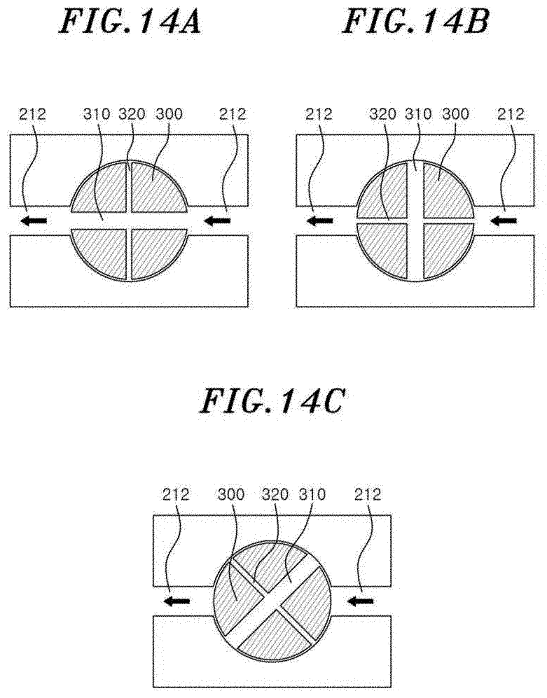

In another example, as shown in FIGS. 14A to 14C, the plurality of adjustment flow paths 310 and 320 may be disposed to intersect each other. In other words, the first adjustment flow path 310 and the second adjustment flow path 320 may intersect each other. The flow path adjuster 300 may be rotated about the second direction so that one of the plurality of adjustment flow paths 310 and 320 may communicate with the connection flow path 212 or the plurality of adjustment flow paths 310 and 320 may be prevented from communicating with the connection flow path 212. In other words, any one of the first adjustment flow path 310 and the second adjustment flow path 320 may communicate with the connection flow path 212 by the flow path adjuster 300 that is rotated about the second direction.

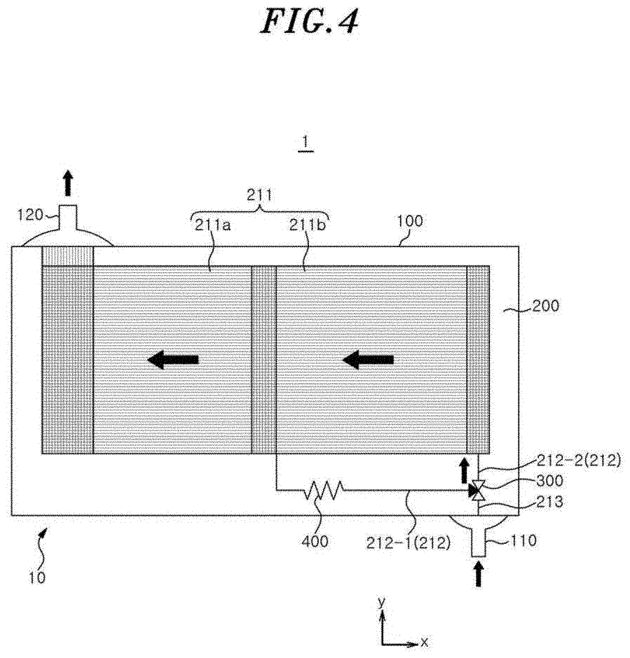

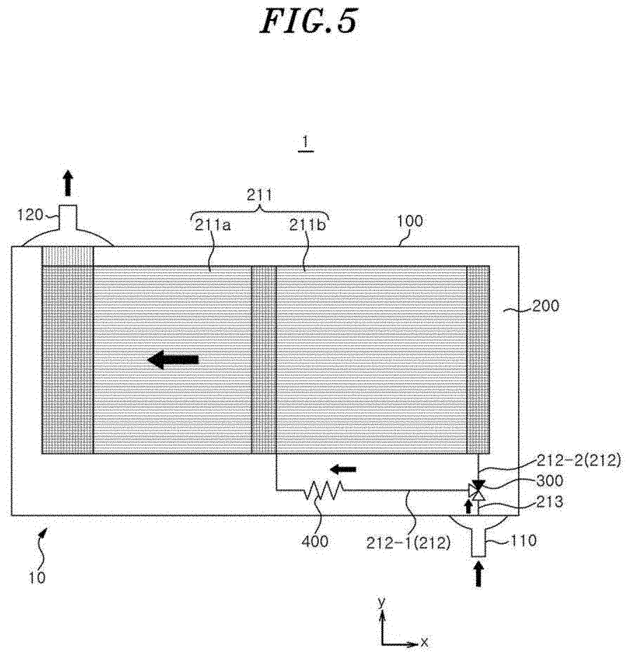

Hereinafter, with reference to FIGS. 4 and 5, it will be described that the flow path adjuster 300 is disposed at a portion where the plurality of connection flow paths 212 and the inflow path 213 are joined. The plurality of connection flow paths 212 connected to the inflow path 213 may be two or more.

The flow path adjuster 300 may be, by the actuator 20, moved in the first direction or the second direction or rotated about the second direction to open and/or close at least one of the plurality of connection flow paths 212. The flow path adjuster 300 may be a three-way valve, but the present disclosure is not limited thereto.

For example, as shown in FIGS. 4 and 5, the plurality of connection flow paths 212 may include a first connection flow path 212-1 for transferring a fluid to the first transfer flow path portion 211a, and a second connection flow path 212-2 for transferring a fluid to the second transfer flow path portion 211b. The flow path adjuster 300 may be disposed at a portion where the first connection flow path 212-1 and the second connection flow path 212-2 are joined. As shown in FIG. 4, the flow path adjuster 300 may open the second connection flow path 212-2 and close the first connection flow path 212-1 so that the fluid flows to the second transfer flow path portion 211b. In addition, as shown in FIG. 5, the flow path adjuster 300 may close the second connection flow path 212-2 and open the first connection flow path 212-1 so that the fluid flows to the first transfer flow path portion 211a.

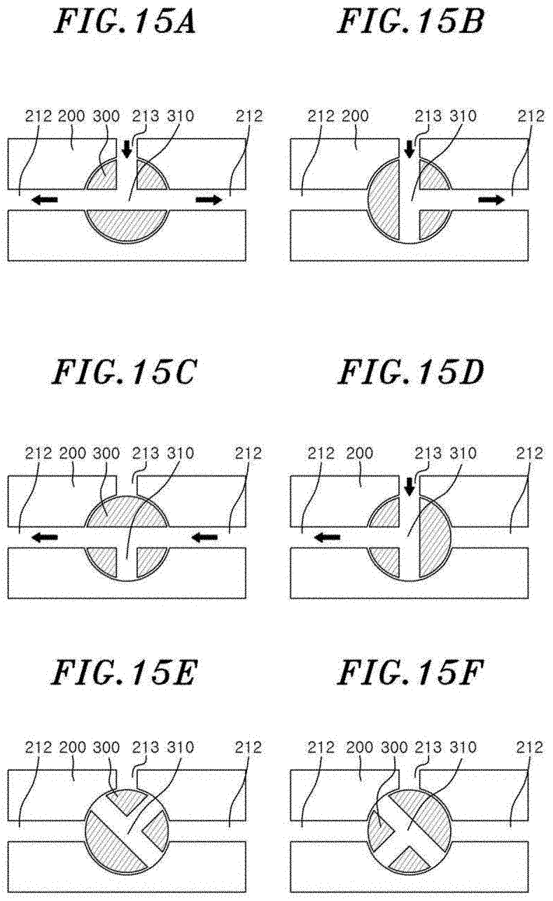

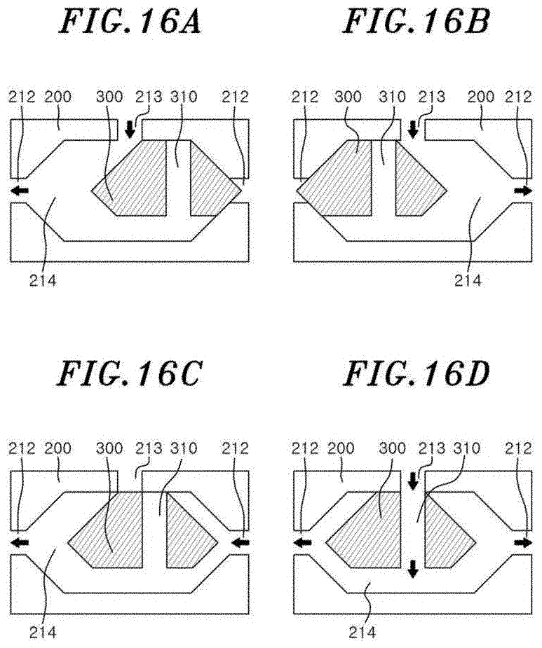

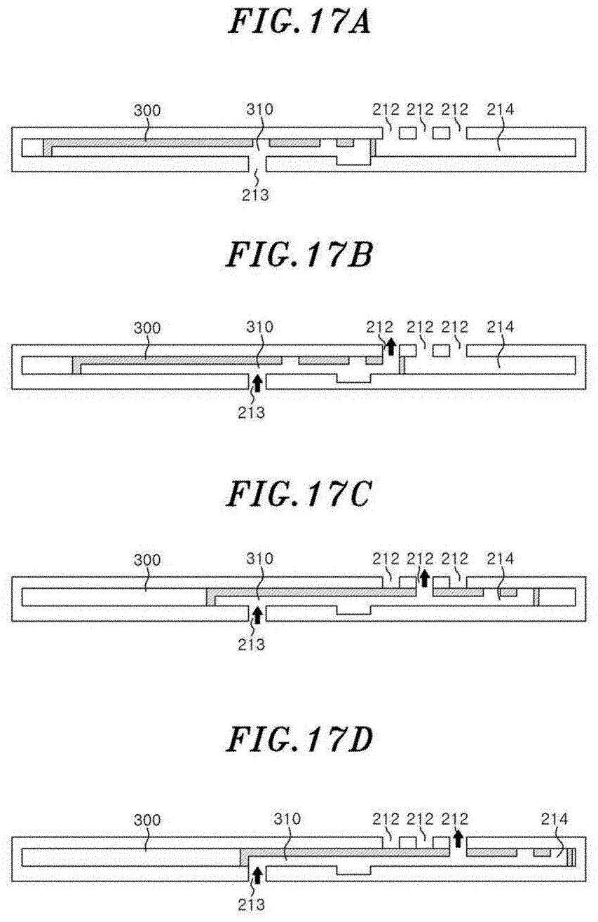

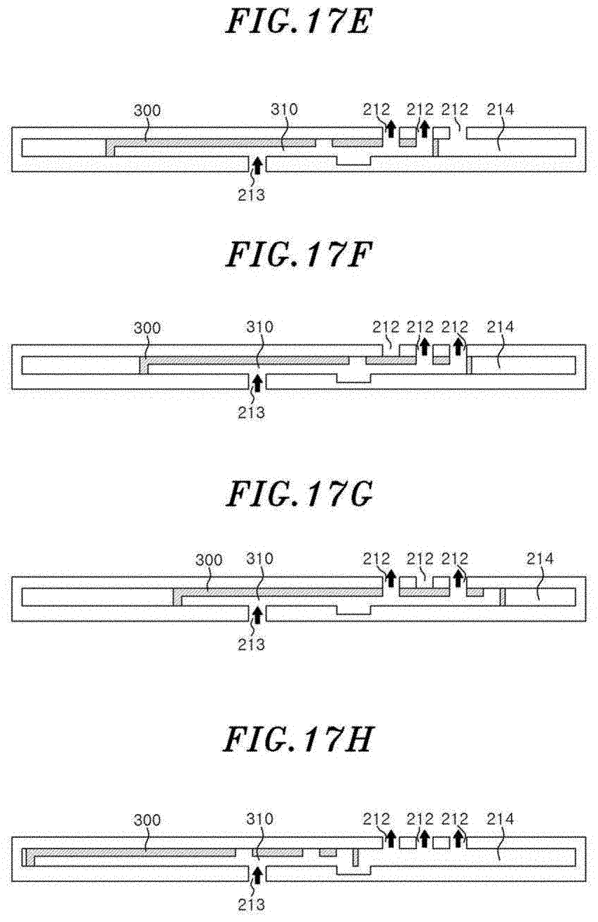

An adjustment flow path 310 may be formed in the flow path adjuster 300. The adjustment flow path 310 may communicate with at least one of the plurality of connection flow paths 212 by movement of the flow path adjuster 300 so as to open or close at least one of the plurality of connection flow paths 212. In other words, the fluid flowing in the inflow path 213 may flow to at least one of the plurality of connection flow paths 212 through the adjustment flow path 310. For example, as shown in FIGS. 15A to 15F, the flow path adjuster 300 may be rotated about the second direction to open at least one of the adjustment flow path 310 and the plurality of connection flow paths 212 or close all of the plurality of connection flow paths 212. In another example, as shown in FIGS. 16A to 17H, the flow path adjuster 300 may be moved in the first direction to open at least one of the plurality of connection flow paths 212 or close all of the plurality of connection flow paths 212. In this case, the fluid may flow to at least one of the plurality of connection flow paths 212 through at least one of the adjustment flow path 310 and the adjuster room 214.

In addition, a plurality of adjustment flow paths 310 and 320 may be formed in the flow path adjuster 300. One of the plurality of adjustment flow paths 310 and 320 may be connected to one of the plurality of connection flow paths 212 by movement of the flow path adjuster 300. In addition, the other one of the plurality of adjustment flow paths 310 and 320 may communicate with the other one of the plurality of connection flow paths 212 by movement of the flow path adjuster 300. In addition, the plurality of adjustment flow paths 310 and 320 may be blocked from the plurality of connection flow paths 212 by movement of the flow path adjuster 300.

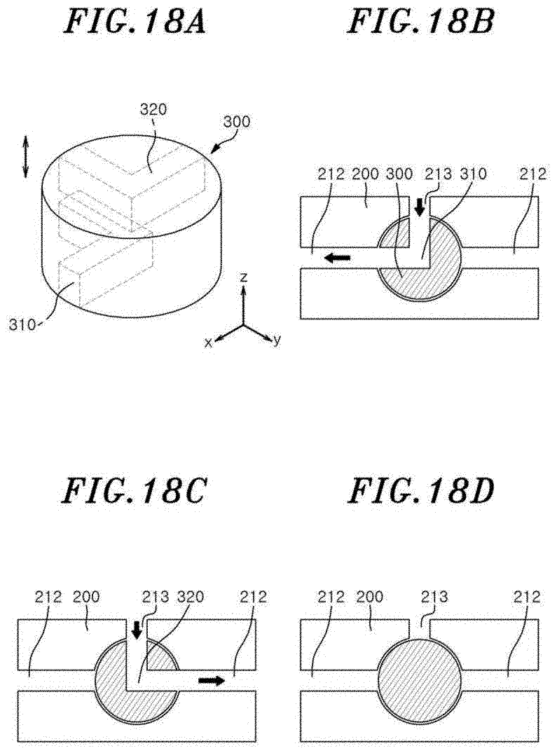

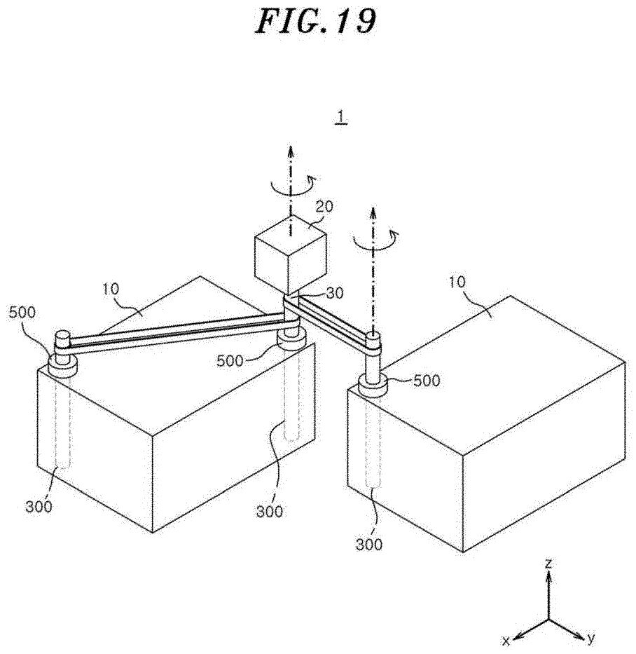

The plurality of adjustment flow paths 310 and 320 may include the first adjustment flow path 310 and the second adjustment flow path 320. The first adjustment flow path 310 may be connected to one of the plurality of connection flow paths 212 by movement of the flow path adjuster 300, and the second adjustment flow path 320 may be connected to the other one of the plurality of connection flow paths 212 by movement of the flow path adjuster 300. For example, as shown in FIGS. 18A to 18D, the first adjustment flow path 310 and the second adjustment flow path 320 may be disposed to be spaced apart from each other in the second direction (the z direction in FIG. 18A), and the flow path adjuster 300 may be moved in the second direction. The first adjustment flow path 310 and the second adjustment flow path 320 may be formed to discharge fluids in different directions. In addition, when the plurality of adjustment flow paths 310 and 320 is disposed to be spaced apart from each other in the second direction, the flow path adjuster 300 may be moved in the second direction so that the plurality of adjustment flow paths 310 and 320 and the plurality of connection flow paths 212 are communicated or blocked from each other in an arbitrary combination.

Meanwhile, the flow path adjuster 300 may be moved in the first direction without an adjustment flow path so that at least one of the plurality of connection flow paths 212 can be opened or closed. In addition, the flow path adjuster 300 may be moved in the first direction so that all of the plurality of connection flow paths can be closed. A fluid flowing from the inflow path 213 by the flow path adjuster 300 may flow into an opened connection flow path 212 among the plurality of connection flow paths 212 through the adjuster room 214.

Referring back to FIGS. 2 to 5, the orifice 400 may be provided in at least one of the plurality of connection flow paths 212 to change flow path resistance of the connection flow paths 212. The orifice 400 may suppress flow instability resulting from boiling of the fluid. For example, the orifice 400 may provide a flow path with a width smaller than a width of the inflow path 213, provide a zigzag-shaped flow path that repeatedly changes in a flow direction of the fluid, or provide a flow path in which a width repeatedly changes. In addition, a plurality of orifices 400 may include a first orifice and a second orifice.

The first orifice may be provided in one of the plurality of connection flow paths 212. The second orifice may be provided in the other one of the plurality of connection flow paths 212 and may have a pressure loss coefficient different from that of the first orifice. In addition, the pressure loss coefficient of the second orifice may be lower than the pressure loss coefficient of the first orifice. In this case, the flow path adjuster 300 may be moved or rotated to close at least one of the plurality of connection flow paths 212 so that a fluid flows into the connection flow path 212 where the first orifice and the second orifice are not provided, the fluid flows into a connection flow path 212 in which the second orifice is provided among the plurality of connection flow paths 212, or the fluid flows into a connection flow path 212 where the first orifice is provided among the plurality of connection flow paths 212. In other words, when the nuclear power plant 1 is operated under conditions of low power and low flow rate, the flow path adjuster 300 may be moved or rotated so that a fluid flows to a connection flow path 212 having the first orifice, and when the nuclear power plant 1 is operated under conditions of high power and high flow rate, the flow path adjuster 300 may be moved or rotated so that a fluid flows to a connection flow path 212 not having the orifice or to a connection flow path 212 having the second orifice with a pressure loss coefficient lower than that of the first orifice.

For example, when the plurality of connection flow paths 212 include a first connection flow path, a second connection flow path, and a third connection flow path, the first orifice may be provided in the first connection flow path, and the second orifice may be provided in the second connection flow path, and no orifice may be provided in the third connection flow path. In this case, the flow path adjuster 300 may be moved in the first direction or the second direction or rotated about the second direction so that the fluid flows to any one of the first connection flow path, the second connection flow path, and the third connection flow path.

In addition, referring to FIGS. 6 and 7, the orifice 400 may be positioned in the flow path adjuster 300 disposed between the inflow path 213 and the connection flow path 212, and, if necessary, pressure loss caused by the flow of fluid in the connection flow path 212 may be minimized by changing the pressure loss coefficient of the orifice or changing to a flow path of the same type as that of the connection flow path 212. For example, at least one of the plurality of adjustment flow paths 310 of the flow path adjuster 300 may be formed as an orifice 400. In other words, the adjustment flow path 310 and the orifice 400 may be provided in the flow path adjuster 300. Thus, the fluid may flow to a connection flow path through the orifice 400 or the adjustment flow path 310.

The orifice 400 may be connected to the inflow path 213 and the connection flow path 212 as the flow path adjuster 300 is moved in the first direction or the second direction or rotated about the second direction. In other words, the orifice 400 may be positioned between the inflow path 213 and the connection flow path 212 by movement or rotation of the flow path adjuster 300. The flow path adjuster 300 may be moved or rotated to open or close at least one of the plurality of connection flow paths 212 by the orifice 400 so that the fluid flows to a connection flow path in which the orifice is provided or a connection flow path 212 where the orifice is not provided.

For example, the adjustment flow path 310 and the orifice 400 may be disposed in the flow path adjuster 300 to be spaced apart from each other along the second direction. In this case, the flow path adjuster 300 may be moved in the second direction so that the adjustment flow path 310 or the orifice 400 is connected to the connection flow path 212. In other words, as shown in FIG. 6, the flow path adjuster 300 may be moved in the second direction to connect the orifice 400 and the connection flow path 212 so that the fluid flows to the connection flow path 212 through the orifice 400. In addition, as shown in FIG. 7, the flow path adjuster 300 may be moved in the second direction to connect the adjuster room 310 and the connection flow path 212 so that the fluid flows to the connection flow path 212 through the adjustment flow path 310.

In another example, the adjustment flow path 310 and the orifice 400 may be disposed in the flow path adjuster 300 to be spaced apart from each other along the first direction. In this case, the flow path adjuster 300 may be moved in the first direction so that the adjustment flow path 310 or the orifice 400 is connected to the connection flow path 212. In other words, the flow path adjuster 300 may be moved in the first direction to connect the orifice 400 and the connection flow path 212 so that the fluid flows to the connection flow path 212 through the orifice 400. In addition, the flow path adjuster 300 may be moved in the first direction to connect the adjustment flow path 310 and the connection flow path 212 so that the fluid flows to the connection flow path 212 through the adjustment flow path 310.

In another example, the adjustment flow path 310 and the orifice 400 may be disposed in the flow path adjuster 300 to intersect each other. In this case, the flow path adjuster 300 may be rotated about the second direction so that the adjustment flow path 310 or the orifice 400 is connected to the connection flow path 212. In other words, the flow path adjuster 300 may be rotated about the second direction to connect the orifice 400 and the connection flow path 212 so that the fluid flows to the connection flow path 212 through the orifice 400. In addition, the flow path adjuster 300 may be rotated about the second direction to connect the adjustment flow path 310 and the connection flow path 212 so that a fluid flows to the connection flow path 212 through the adjustment flow path 310.

In addition, a plurality of orifices 400 may be provided and may provide different pressure loss coefficients, respectively. By means of the plurality of orifices 400, the flow path adjuster 300 may be moved in the first direction or the second direction or rotated about the second direction so that an orifice corresponding to a required pressure loss coefficient among the plurality of orifices 400 or the adjustment flow path 310 is disposed between the inflow path 213 and the connection flow path 212. The adjustment flow path 310 may be changed to a flow path of the same type so as to minimize pressure loss caused by a fluid flow in the connection flow path 212.

The plurality of orifices 400 formed in the flow path adjuster 300 may include a first orifice and a second orifice having a pressure loss coefficient different from that of the first orifice. In this case, when the nuclear power plant 1 is operated under conditions of low power and low flow rate, the flow path adjuster 300 may be moved or rotated to connect the first orifice with the connection flow path 212, and when the nuclear power plant 1 is operated under high power and high flow rate conditions, the flow path adjuster 300 may be moved or rotated to connect the connection flow path 212 and the second orifice having a pressure loss coefficient lower than that of the first orifice or to connect the connection flow path 212 and an adjustment flow path 310 having a low pressure loss coefficient.

For example, the adjustment flow path 310, the first orifice, and the second orifice may be disposed in the flow path adjuster 300 to be spaced apart from each other in the second direction. In this case, the flow path adjuster 300 may be moved in the second direction so that the adjustment flow path 310, the first orifice, or the second orifice is connected to the connection flow path 212. In other words, the flow path adjuster 300 may be moved in the second direction to connect the first orifice and the connection flow path 212 so that a fluid flows to the connection flow path 212 through the first orifice. In addition, the flow path adjuster 300 may be moved in the second direction to connect the second orifice and the connection flow path 212 so that a fluid flows to the connection flow path 212 through the second orifice. In addition, the flow path adjuster 300 may be moved in the second direction to connect the adjustment flow path 310 and the connection flow path 212 so that a fluid flows to the connection flow path 212 through the adjustment flow path 310.

In another example, the adjustment flow path 310, the first orifice, and the second orifice may be disposed at the flow path adjuster 300 to be spaced apart from each other in the first direction. In this case, the flow path adjuster 300 may be moved in the first direction so that the adjustment flow path 310, the first orifice, or the second orifice is connected to the connection flow path 212. In other words, the flow path adjuster 300 may be moved in the first direction to connect the first orifice and the connection flow path 212 so that a fluid flows to the connection flow path 212 through the first orifice. In addition, the flow path adjuster 300 may be moved in the first direction to connect the second orifice and the connection flow path 212 so that a fluid flows to the connection flow path 212 through the second orifice. In addition, the flow path adjuster 300 may be moved in the first direction to connect the adjustment flow path 310 and the connection flow path 212 so that the fluid flows to the connection flow path 212 through the adjustment flow path 310.

In another example, the adjustment flow path 310, the first orifice, and the second orifice may be disposed in the flow path adjuster 300 to intersect each other. In this case, the flow path adjuster 300 may be rotated about the second direction so that the adjustment flow path 310, the first orifice, or the second orifice is connected to the connection flow path 212. In other words, the flow path adjuster 300 may be rotated about the second direction to connect the first orifice and the connection flow path 212 so that a fluid flows to the connection flow path 212 through the first orifice. In addition, the flow path adjuster 300 may be rotated about the second direction to connect the second orifice and the connection flow path 212 so that a fluid flows to the connection flow path 212 through the second orifice. In addition, the flow path adjuster 300 may be rotated about the second direction to connect the adjustment flow path 310 and the connection flow path 212 so that a fluid flows to the connection flow path 212 through the adjustment flow path 310.

The orifice 400 may be formed in at least one of the second flow module and the flow path adjuster to suppress flow instability resulting from boiling of the second fluid. For example, the orifice 400 may be formed at a fixed portion in the second flow path module, and the fixed portion in the second flow path module may refer to the connection flow path 212. In addition, the orifice 400 may vary a pressure loss of the second flow path module through which the second fluid flows by the flow path adjuster 300.

A cover portion 500 is provided at an exterior of the body 100 to prevent the flow path adjuster 300 from being separated from the body 100 and to prevent the first fluid or the second fluid from leaking to the outside of the body 100 through a gap between the flow path adjuster 300 and the plate 200. For example, the cover portion 500 may be connected to the flow path adjuster 300 protruding to the outside of the body 100. In addition, a packing may be installed between the cover portion 500 and the flow path adjuster 300. The cover portion 500 may be provided in plural to cover both ends of the flow path adjuster 300 passing through the body 100.

The actuator 20 may provide a driving force for moving one or more flow path adjusters 300. In other words, at least one of the plurality of flow path adjusters 300 may be simultaneously moved by the actuator 20.

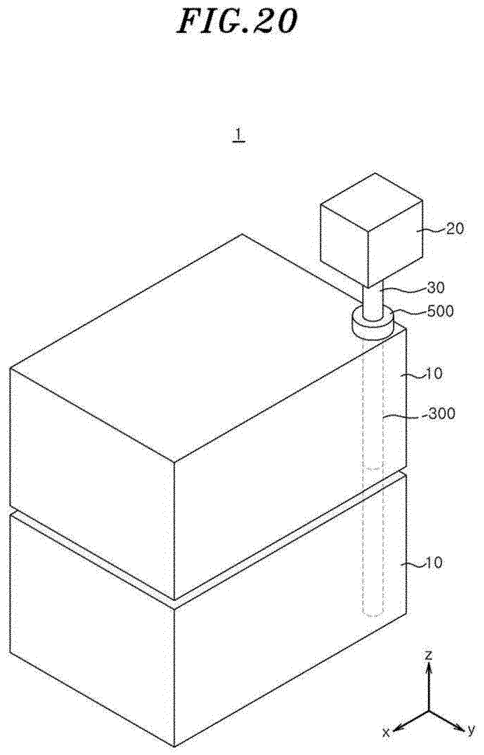

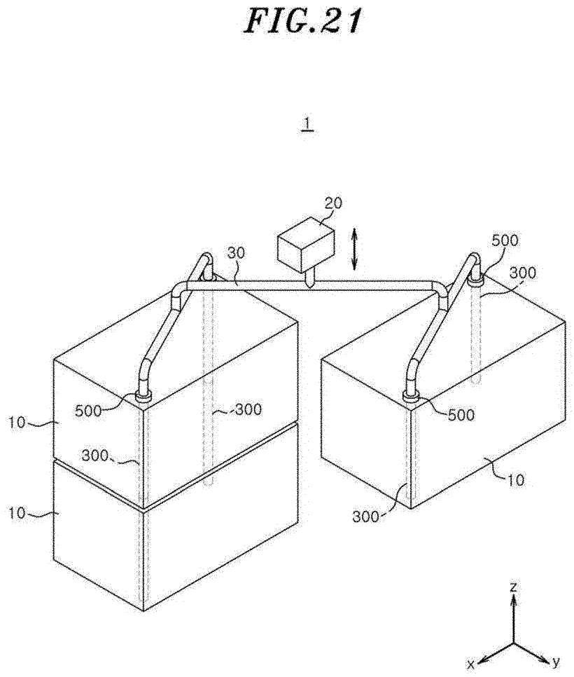

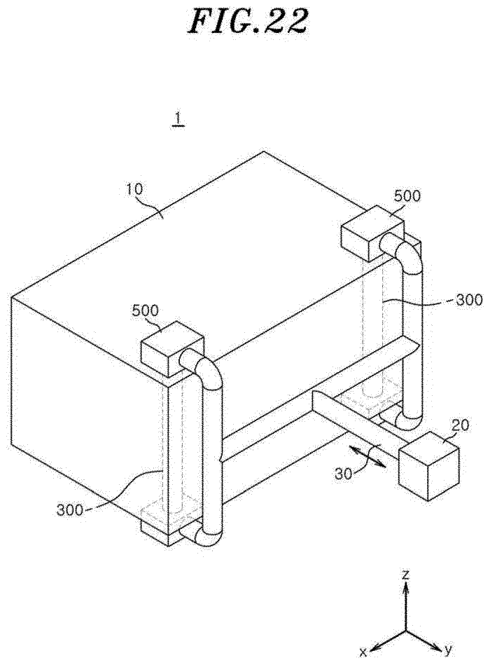

Referring to FIGS. 19 to 22, the connection member 30 may be connected to the plurality of flow path adjusters 300 to transfer the driving force of the actuator 20 to a single flow path adjuster 300 or a plurality of flow path adjusters 300 provided at a single heat exchanger 10 or a plurality of heat exchangers 10. The flow path adjusters 300 respectively provided in the plurality of heat exchangers 10 via the connection member 30 may be simultaneously moved in the first direction, rotated about the first direction, moved in the second direction, or rotated about the second direction. In addition, the connecting member 30 may pass through the cover portion 500 to be connected to the flow path adjuster 300.

Hereinafter, operation and effects of the nuclear power plant 1 according to the embodiment of the present disclosure will be described.

In the heat exchanger 10 of the nuclear power plant 1 according to the embodiment of the present disclosure, the fluid is selectively flowed as needed in the plurality of transfer flow paths 211 by the flow path adjuster 300, or the fluid selectively passes the orifice 400 based on the output power of the nuclear power plant 1. Accordingly, the flow path resistance of at least a part of the flow module is adjusted so that the heat exchanger 10 can be operated in a state where the characteristics thereof are optimal depending on output power of the nuclear power plant 1. For example, when a high flow rate of the second fluid is supplied for the high-power operation, it is possible to limit the pressure loss while securing the amount of heat transfer by preventing the second fluid from passing through the orifice 400 using the flow path adjuster 300 to increase the passage length of the transfer flow path portion 211. On the other hand, during a low-power operation, a low flow rate of the second fluid is supplied and flow instability may be intensified due to boiling of the second fluid. In this case, the second fluid may be controlled using the flow path adjuster 300 to pass through the orifice 400 having a high pressure loss coefficient and a passage length of the transfer flow path portion 211 of the flow path module 210 may be reduced, thereby limiting a pressure loss while suppressing the flow instability.

In addition, in the event of an accident at the nuclear power plant 1, when residual heat removal such as an operation of a passive residual heat removal system is in progress, a fluid is allowed to flow only in some of the plurality of transfer flow path portions 211 or is prevented from passing through the orifice 400 by the flow path adjuster 300, thereby reducing a pressure loss in the flow path module, which increases an amount of heat removed and thereby improves safety of the nuclear power plant 1.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A heat exchanger comprising:
a body having an inlet header through which a fluid is introduced, and an outlet header through which the fluid is discharged;
one or more plates accommodated in the body and provided with flow path modules providing flow paths for the fluid introduced through the inlet header to flow to the outlet header; and
at least one flow path adjuster each having at least a portion thereof accommodated in the body and being movable or rotatable to open or close a part or all of the flow paths or to change directions of the flow paths so that a flow of the fluid is adjusted.

2. The heat exchanger of claim 1, wherein the at least one flow path adjuster is movable in a first direction along surfaces of the one or more plates, rotatable about the first direction, movable in a second direction crossing the first direction, or rotatable about the second direction.

3. The heat exchanger of claim 2, wherein the flow path modules comprise a plurality of transfer flow path portions communicating with each other and providing a plurality of passages through which the fluid flows to the outlet header, and
wherein the fluid flows to at least one of the plurality of transfer flow path portions by the at least one flow path adjuster.

4. The heat exchanger of claim 3, wherein the plurality of transfer flow path portions comprises a first transfer flow path portion communicating with the outlet header, and a second transfer flow path portion communicating with the first transfer flow path portion,
wherein the fluid flows to at least one of the first transfer flow path portion and the second transfer flow path portion by the at least one flow path adjuster.

5. The heat exchanger of claim 3, wherein the flow modules further comprise a plurality of connection flow paths respectively connected to the plurality of transfer flow path portions to provide flow paths through which the fluid introduced through the inlet header is transferred to the plurality of transfer flow path portions, and
wherein the at least one flow path adjuster is provided at the plurality of connection flow paths and is moved or rotated to open and close the plurality of connection flow paths, respectively.

6. The heat exchanger of claim 5, wherein at least one adjustment flow path through which the fluid is allowed to flow is formed in the at least one flow path adjuster, and
wherein by the movement or rotation of the at least one flow path adjuster, the at least one adjustment flow path communicates with the plurality of connection flow paths or the communication between the at least one adjustment flow path and the plurality of connection flow paths is blocked.

7. The heat exchanger of claim 6, wherein the at least one adjustment flow path includes a plurality of adjustment flow paths,
wherein the plurality of adjustment flow paths is formed in different shapes, and
wherein the at least one flow path adjuster is moved or rotated to allow one of the plurality of adjustment flow paths to communicate with the plurality of connection flow paths or to block the communication between the plurality of adjustment flow paths and the plurality of connection flow paths.

8. The heat exchanger of claim 7, wherein the plurality of adjustment flow paths is disposed to be spaced apart from each other in the first direction, and
wherein the flow path adjuster is moved in the first direction to allow one of the plurality of adjustment flow paths to communicate with one of the plurality of connection flow paths or to block the communication between the plurality of adjustment flow paths and the plurality of connection flow paths.

9. The heat exchanger of claim 7, wherein the plurality of adjustment flow paths is disposed to be spaced apart from each other in the second direction, and
wherein the at least one flow path adjuster is moved in the second direction to allow one of the plurality of adjustment flow paths to communicate with one of the plurality of connection flow paths or to block the communication between the plurality of adjustment flow paths and the plurality of connection flow paths.

10. The heat exchanger of claim 7, wherein the plurality of adjustment flow paths is arranged to intersect each other, and
wherein the at least one flow path adjuster is rotated about the second direction to allow one of the plurality of adjustment flow paths to communicate with one of the plurality of connection flow paths or to block the communication between the plurality of adjustment flow paths and the plurality of connection flow paths.

11. The heat exchanger of claim 3, wherein the flow modules comprise a plurality of connection flow paths respectively connected to the plurality of transfer flow path portions to provide passages through which the fluid is transferred to the plurality of transfer flow path portions, and
wherein the at least one flow path adjuster is moved or rotated to open or close at least one of the plurality of connection flow paths.

12. The heat exchanger of claim 11, wherein a plurality of adjustment flow paths through which the fluid flows is formed in the at least one flow path adjuster,
wherein the plurality of adjustment flow paths is disposed to be spaced apart from each other in the second direction, and
wherein the at least one flow path adjuster is moved in the second direction so that the plurality of adjustment flow paths and the plurality of connection flow paths are connected with each other or are blocked from each other in an arbitrary combination.

13. The heat exchanger of claim 11, wherein the flow path modules further comprise an adjuster room accommodating a portion of the at least one flow path adjuster and providing a space in which the at least one flow path adjuster is movable in the first direction, and
wherein the at least one flow path adjuster is moved in the first direction to open at least one of the plurality of connection flow paths so that the fluid flows to the at least one connection flow path through the adjuster room, or the at least one flow path adjuster is moved in the first direction to close the plurality of connection flow paths.

14. The heat exchanger of claim 1, wherein the one or more plates are assembled by diffusion bonding.

15. The heat exchanger of claim 11, further comprising:
an orifice provided in one or more of the plurality of connection flow paths to suppress flow instability resulting from boiling of the fluid,
wherein the at least one flow path adjuster is moved or rotated to open and close one or more of the plurality of connection flow paths so that the fluid flows to a connection flow path having the orifice or to a connection flow path without the orifice.

16. The heat exchanger of claim 15, wherein the orifice includes a plurality of orifices, and the plurality of orifices includes:
a first orifice provided in one of the plurality of connection flow paths; and
a second orifice provided in another one of the plurality of connection flow paths and having a pressure loss coefficient different from a pressure loss coefficient of the first orifice, and
wherein the at least one flow path adjuster is moved or rotated so that the fluid flows to the connection flow path having the first orifice among the plurality of connection flow paths, the fluid flows to the connection path having the second orifice among the plurality of connection flow paths, or the fluid flows to a connection path having neither the first orifice nor the second orifice.

17. The heat exchanger of claim 5, further comprising:
at least one orifice formed in the at least one flow path adjuster to suppress flow instability resulting from boiling of the fluid,
wherein at least one adjustment flow path through which the fluid is allowed to flow is formed in the at least one flow path adjuster,
wherein one of the at least one orifice and the at least one adjustment flow path is connected to the connection flow path by movement or rotation of the at least one flow path adjuster, and
wherein the fluid flows to the connection flow path through the one of the at least one orifice and the at least one adjustment flow path.

18. The heat exchanger of claim 17, wherein the at least one adjustment flow path and the at least one orifice are disposed to be spaced apart from each other in the first direction, and
wherein the at least one flow path adjuster is moved in the first direction to connect one of the at least one orifice and the at least one adjustment flow path with the connection flow path.

19. The heat exchanger of claim 17, wherein the at least one adjustment flow path and the at least one orifice are disposed to be spaced apart from each other in the second direction, and
wherein the at least one flow path adjuster is moved in the second direction to connect one of the at least one orifice and the at least one adjustment flow path with the connection flow path.

20. The heat exchanger of claim 17, wherein the at least one adjustment flow path and the at least one orifice are disposed to intersect each other, and
wherein the at least one flow path adjuster is rotated about the second direction to connect the connection flow path to one of the at least one orifice and the at least one adjustment flow path.
